(19) United States
(12) Patent Application Publication
(10) Pub. No.: US 2015/0243010 A1
(43) Pub. Date: Aug. 27, 2015

(54) IMAGE INSPECTION DEVICE, IMAGE INSPECTION SYSTEM, AND RECORDING MEDIUM STORING IMAGE INSPECTION PROGRAM

(71) Applicant: Hitomi KANEKO, Saitama (JP)

(72) Inventor: Hitomi KANEKO, Saitama (JP)

(73) Assignee: RICOH COMPANY, LTD., Tokyo (JP)

(21) Appl. No.: 14/631,414

(22) Filed: Feb. 25, 2015

(30) Foreign Application Priority Data
Feb. 26, 2014 (JP) 2014-035705
Feb. 13, 2015 (JP) 2015-026691

(51) Int. Cl. G06T 7/00; H04N 1/00

(52) U.S. Cl. CPC G06T 7/001; G06T 7/0008; H04N 1/00005; H04N 1/00037; G06T 2207/10008; G06T 2207/30168; G06T 2207/30144

(57) ABSTRACT

An image inspection device, an image inspection system, and a recording medium storing an image inspection program are provided. Each of the image inspection device and the inspection program includes generating a plurality of inspection images for inspecting a read image obtained by reading an output image formed and output by an image forming apparatus, and determining whether the read image is defective based on a difference image indicating a difference between the read image and at least one of the plurality of generated inspection images. The image inspection system includes an image forming unit configured to form and output an output image on a recording medium, an image reading unit configured to read an image from the recording medium to generate a read image, a read-image acquisition unit, an inspection image generation unit, and a defect determination unit.

### CROSS-REFERENCE TO RELATED APPLICATIONS

This patent application is based on and claims priority pursuant to 35 U.S.C. §119(a) to Japanese Patent Application Nos. 2014-035705 and 2015-026691, filed on Feb. 26, 2014, and Feb. 13, 2015, respectively in the Japan Patent Office, the entire disclosure of which is hereby incorporated by reference herein.

### BACKGROUND

1. Technical Field

Example embodiments of the present invention generally relate to an image inspection device, an image inspection system, and a recording medium storing an image inspection program.

2. Background Art

Conventionally, printed materials were manually inspected. Recently, apparatuses that inspect printed materials are used as post-processing apparatuses in offset printing. Such inspection apparatuses determine whether the printed material is defective as follows. Firstly, an ideal image is selected from the scanned images of printed materials, and is scanned to generate a master image. Then, the master image is compared with the scanned image of the printed material, and whether the printed material is defective or not is determined based on the degree of the difference.

However, in plateless printing such as electrophotography that is widespread, a small number of pages are usually printed. What is more, each page is printed differently in variable-data printing. For this reason, it is inefficient to generate a master image from a printed material and to use the generated master image as an object to be compared as in offset printing. In order to deal with such inefficiency, a master image may be generated from printing data. By so doing, variable-data printing can be performed efficiently.

### SUMMARY

Embodiments of the present invention described herein provide an image inspection device, an image inspection system, and a recording medium storing an image inspection program. Each of the image inspection device and the inspection program includes generating a plurality of inspection images for inspecting a read image obtained by reading an output image formed and output by an image forming apparatus, and determining whether the read image is defective based on a difference image indicating a difference between the read image and at least one of the plurality of generated inspection images. The image inspection system includes an image forming unit configured to form and output an output image on a recording medium based on an image to be formed and output, an image reading unit configured to read an image from the recording medium to generate a read image, a read-image acquisition unit configured to acquire the generated read image, an inspection image generation unit configured to generate a plurality of inspection images for inspecting the acquired read image, and a defect determination unit configured to determine whether the read image is defective based on a difference image indicating a difference between the read image and at least one of the plurality of generated inspection images.

### BRIEF DESCRIPTION OF THE SEVERAL VIEWS OF THE DRAWINGS

A more complete appreciation of exemplary embodiments and the many attendant advantages thereof will be readily obtained as the same becomes better understood by reference to the following detailed description when considered in connection with the accompanying drawings.

FIG. 1 illustrates a schematic configuration of an image inspection system including an inspection device, according to an example embodiment of the present invention.

FIG. 2 is a block diagram illustrating the hardware configuration of an inspection device according to an example embodiment of the present invention.

FIG. 3 is a block diagram illustrating the functional configuration of a digital front end (DFE), an engine controller, a print engine, and an inspection device, according to an example embodiment of the present invention.

FIG. 4 illustrates a model of comparison according to an example embodiment of the present invention.

FIG. 5 illustrates the structure of a print engine, an inspection device, and a stacker, according to an example embodiment of the present invention.

FIG. 6 is a block diagram illustrating the functional configuration of a master-image processing unit according to an example embodiment of the present invention.

FIG. 7 illustrates an example of a multilevel image according to an example embodiment of the present invention.

FIGS. 8A to 8D illustrate examples of the region segmentation of a multilevel image according to an example embodiment of the present invention.

FIGS. 9A to 9D illustrate examples of resolution-converted image according to an example embodiment of the present invention.

FIG. 10 is a block diagram of the functional configuration of an inspection controller according to an example embodiment of the present invention.

FIG. 11 is a flowchart of the series of processes of determining whether a scanned image is defective, which are performed by the components of an inspection device according to an example embodiment of the present invention.

FIG. 12 is a flowchart depicting the processes of generating a plurality of resolution-converted images performed by a resolution converter according to an example embodiment of the present invention.

The accompanying drawings are intended to depict exemplary embodiments of the present disclosure and should not be interpreted to limit the scope thereof. The accompanying drawings are not to be considered as drawn to scale unless explicitly noted.

### DETAILED DESCRIPTION

The terminology used herein is for the purpose of describing particular embodiments only and is not intended to be limiting of the present invention. As used herein, the singular forms “a”, “an” and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof

In describing example embodiments shown in the drawings, specific terminology is employed for the sake of clarity. However, the present disclosure is not intended to be limited to the specific terminology so selected and it is to be understood that each specific element includes all technical equivalents that have the same structure, operate in a similar manner, and achieve a similar result.

In the following description, illustrative embodiments will be described with reference to acts and symbolic representations of operations (e.g., in the form of flowcharts) that may be implemented as program modules or functional processes including routines, programs, objects, components, data structures, etc., that perform particular tasks or implement particular abstract data types and may be implemented using existing hardware at existing network elements or control nodes. Such existing hardware may include one or more Central Processing Units (CPUs), digital signal processors (DSPs), application-specific-integrated-circuits (ASICs), field programmable gate arrays (FPGAs) computers or the like. These terms in general may be collectively referred to as processors.

Unless specifically stated otherwise, or as is apparent from the discussion, terms such as “processing” or “computing” or “calculating” or “determining” or “displaying” or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

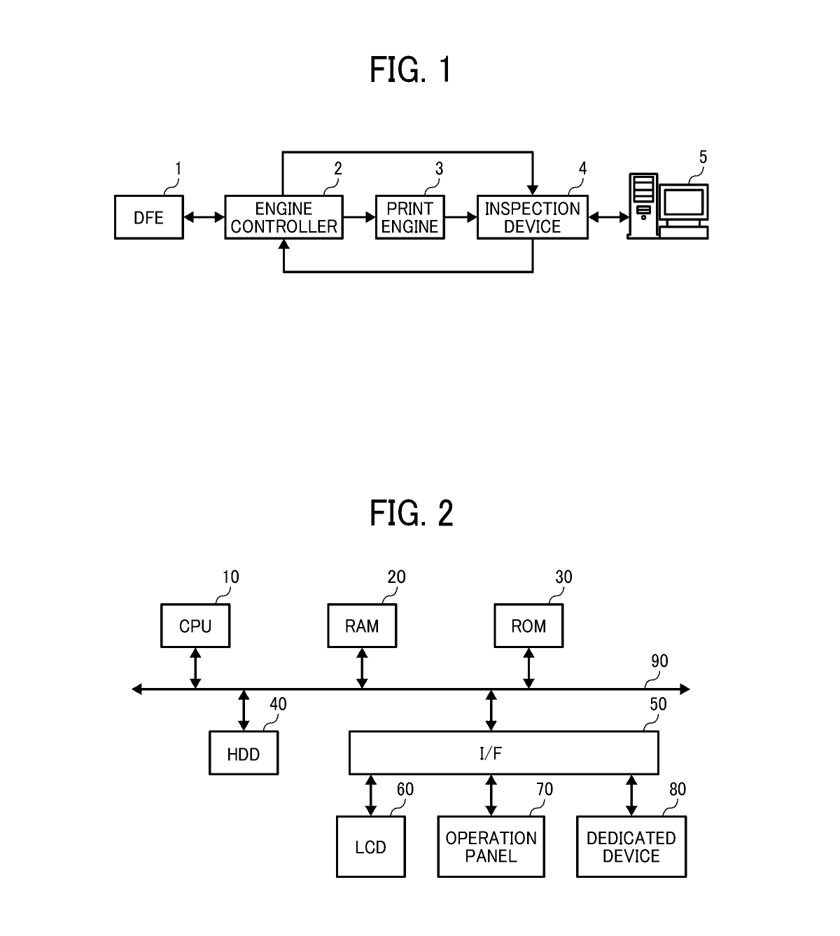

Example embodiments of the present invention will be described below in detail with reference to the drawings. In the present example embodiment, an image inspection system is described including an inspection device that inspects output results by comparing a master image with a scanned image obtained by scanning a formed and output image. Further, functions to improve the accuracy of inspection in such an image inspection system are described. FIG. 1 illustrates a schematic configuration of an image inspection system according to the present example embodiment of the present invention.

As illustrated in FIG. 1, the image inspection system according to the present example embodiment includes a digital front end (DFE) 1, an engine controller 2, a print engine 3, an inspection device 4, and an interface terminal 5. The DFE 1 serves as an image processing apparatus that generates image data to be printed out, i.e., the bit map data of an image to be output, based on the received print job, and transmits the generated bit map data to the engine controller 2.

The engine controller 2 controls the print engine 3 based on the bit map data received from the DFE 1. Accordingly, an image is formed and output. Moreover, the engine controller 2 according to the present example embodiment transmits the bit map data received from the DFE 1 to the inspection apparatus 4. The inspection apparatus 4 uses the received bit map data as a source of inspection images, which are referred to when inspecting the image formed and output by the print engine 3.

The print engine 3 serves as an image forming apparatus that forms and outputs an image on paper as a recording medium in accordance with the control performed by the engine controller 2 based on the bit map data. Note that the recording medium may be other sheet-formed material such as of film and plastic, as long as it is possible to perform image forming thereon.

The inspection device 4 generates a master image based on the bit map data received from the engine controller 2. The inspection device 4 serves as an image inspection device that inspects an output result by comparing the generated master image with the scanned image obtained by scanning the paper output from the print engine 3 using a scanner. In other words, the master image is an image to be formed and output, and the scanned image is generated by scanning the image formed on the recording medium with the scanner based on the image to be formed and output.

When a defect is detected in the output result as a result of the comparison between the master image and the scanned image, the inspection device 4 sends to the engine controller 2 the data that indicates the page on which a defect has been detected. Accordingly, the engine controller 2 controls the re-printing of a defective page.

The interface terminal 5 is an information processing terminal to display a graphical user interface (GUI) for viewing a result of defect detection performed by the inspection device 4 or a GUI for setting parameters used in the inspection. The interface terminal 5 is implemented, for example, by a known information processing terminal such as personal computers (PCs).

Next, the hardware configuration of the DFE 1, the engine controller 2, the print engine 3, the inspection device 4, and the interface terminal 5 according to the present example embodiment is described with reference to FIG. 2. FIG. 2 is a block diagram illustrating the hardware configuration of the inspection device 4 according to the present example embodiment of the present invention. The hardware configuration of the inspection device 4 is illustrated in FIG. 2, but a similar hardware configuration applies to that of the other elements.

As illustrated in FIG. 2, the inspection device 4 according to the present example embodiment has a configuration similar to that of general-purpose information processing devices such as personal computers (PCs) and servers. In other words, a central processing unit (CPU) 10, a random access memory (RAM) 20, a read only memory (ROM) 30, a hard disk drive (HDD) 40, and an interface (I/F) 50 are connected to each other via a bus 90 in the inspection device 4 according to the present example embodiment of the present invention. Moreover, the I/F 50 is connected to a liquid crystal display (LCD) 60, an operation panel 70, and a dedicated device 80.

The CPU 10 serves as a computation unit, and controls the entire operation of the inspection device 4. The RAM 20 is a volatile memory capable of reading and writing data at high speed, and is used as a working area when the CPU 10 processes data. The ROM 30 is a read-only nonvolatile memory in which firmware programs or the like are stored. The volatile HDD 40 is a data readable/writable nonvolatile memory in which an operating system (OS), various kinds of control programs, applications, programs, or the like are stored.

The I/F 50 connects various kinds of hardware, networks, or the like to the bus 90, and controls these elements. The LCD 60 is a user interface that allows a user to visually monitor the state of the inspection device 4. The operation panel 70 is a user interface such as a keyboard or a mouse used to input data to the inspection device 4.

The dedicated device 80 is a hardware device that implements special functions in the engine controller 2, the print engine 3, and the inspection device 4. In the case of the print engine 3, the dedicated device 80 serves as a conveying mechanism that conveys paper on which an image is formed and is output, or a plotter that forms and outputs an image on the paper. In the cases of the engine controller 2 and the inspection device 4, the dedicated device 80 serves as a processing device that performs image processing on an image at high speed. Such a processing device is configured as, for example, an application-specific-integrated-circuit (ASIC). Moreover, the dedicated device 80 may include a scanner that scans the image formed and output on the paper.

In such a hardware configuration, the CPU 10 performs computation according to programs stored on the ROM 30 or programs read on the RAM 20 from the HDD 40 or another recording medium such as an optical disk, to configure a software controller. The software controller as configured above and hardware are combined to configure a functional block that realizes the functions of the DFE 1, the engine controller 2, the print engine 3, the inspection device 4, and the interface terminal 5 according to the present example embodiment of the present invention.

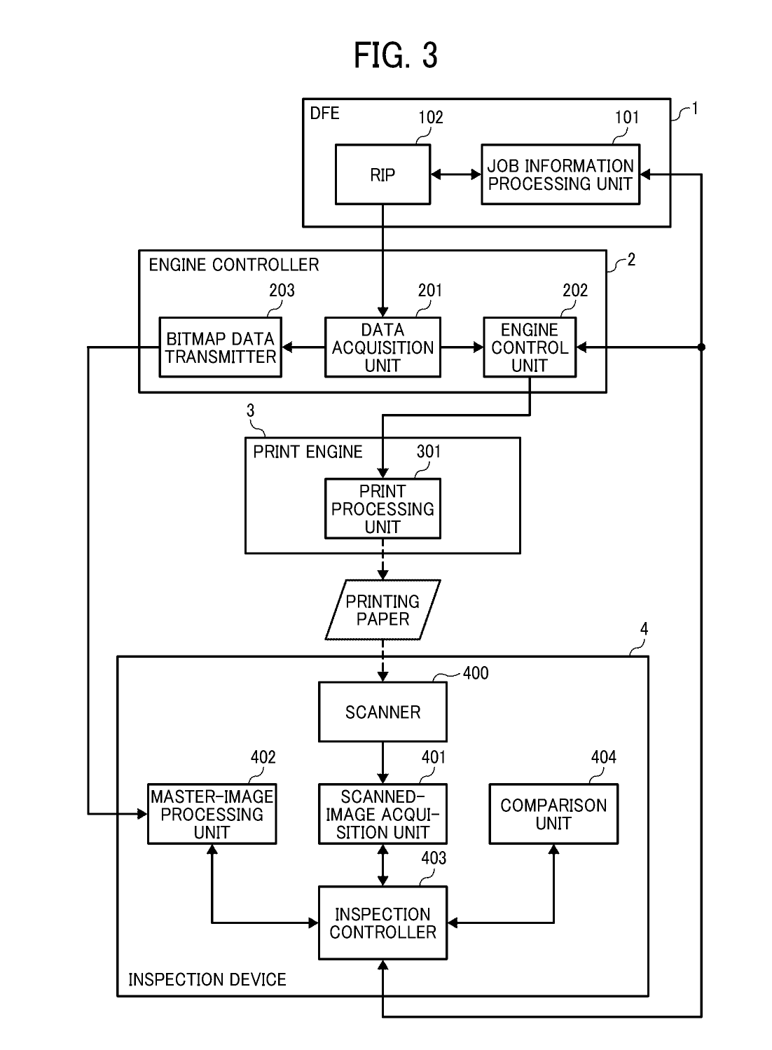

FIG. 3 is a block diagram illustrating the functional configuration of the DFE 1, the engine controller 2, the print engine 3, and the inspection device 4, according to the present example embodiment of the present invention. Note that in FIG. 3 data communication is indicated solid lines, and the flow of paper is indicated by broken lines. As illustrated in FIG. 3, the DFE 1 according to the present example embodiment includes a job information processing unit 101, and a raster image processor (RIP) 102. The engine controller 2 includes a data acquisition unit 201, an engine control unit 202, and a bitmap data transmitter 203. The print engine 3 includes a print processing unit 301. The inspection device 4 includes a scanner 400, a scanned-image acquisition unit 401, a master-image processing unit 402, an inspection controller 403, and a comparison unit 404.

The job information processing unit 101 controls image forming and outputting processes, based on the print job input from the outside of the DFE 1 through the network or the print job generated from the image data stored in the DFE 1. When the image forming and outputting processes are performed, the job information processing unit 101 controls the RIP 102 to generate bit map data based on the image data included in the print job.

In response to the control performed by the job information processing unit 101, the RIP 102 generates the bit map data based on the image data included in the print job. The bit map data generated by the RIP 102 is used by the print engine 3 to perform the image forming and outputting processes. The bit map data consists of the pixels that form an image to be formed and output.

The print engine 3 according to the present example embodiment performs the image forming and outputting processes based on the binary CMYK (cyan, magenta, yellow, black) images. By contrast, it is known that the image data included in a print job is a multilevel image expressed as a multilevel gray scale such as 256-level gray scale per pixel. For this reason, the RIP 102 generates bit map data of binary CMYK images by converting the image data included in the print job from a multilevel image to a fewer-level image, and sends the generated bit map data to the engine controller 2.

The data acquisition unit 201 acquires the bit map data sent from the DFE 1, and transfers the acquired bit map data to the engine control unit 202 and the bitmap data transmitter 203. The engine control unit 202 controls the print engine 3 to performs image forming and outputting processes based on the bit map data transferred from the data acquisition unit 201. The bitmap data transmitter 203 transmits the bit map data acquired by the data acquisition unit 201 to the inspection device 4 for the generation of a master image.

The print processing unit 301 obtains the bit map data sent from the engine controller 2, and serves as an image forming part that forms an image on printing paper and outputs the printing paper on which the image has been formed. The print processing unit 301 according to the present example embodiment is implemented by known electrophotography, but may be implemented using other kinds of image formation mechanisms such as ink-jet imaging.

The scanner 400 serves as an image reading unit that scans the image formed on the surface of the printing paper that is output from the print processing unit 301, and outputs the scanned image. The scanner 400 is, for example, a line scanner disposed within the inspection device 4, on a conveyance path of the printing paper output from the print processing unit 301, and reads the image formed on the paper by scanning the surface of the being-conveyed printing paper.

The scanned image generated by the scanner 400 is inspected by the inspection device 4. Because the scanned image is generated by reading the surface of the paper that is output as a result of image forming and outputting processes, the scanned image represents an output result. The scanned-image acquisition unit 401 acquires the data of the scanned image, which is generated by scanning the surface of printing paper using the scanner 400. The data of the scanned image acquired by the scanned-image acquisition unit 401 is sent to the comparison unit 404 for performing a comparison. Note that the transmission of the scanned image to the comparison unit 404 is performed under the control of the inspection controller 403. In other words, the inspection controller 403 receives the scanned image, and then transfers the received scanned image to the comparison unit 404.

The master-image processing unit 402 receives the bit map data sent from the engine controller 2, as described above, and generates a master image, i.e., an inspection image, used for comparison with the image to be inspected. In other words, the master-image processing unit 402 serves as an inspection image generation unit that generates a master image, i.e., an inspection image, used for inspecting the scanned image, based on the image to be output. The detailed processes of the master image generation by the master-image processing unit 402 are described later in detail.

The inspection controller 403 controls the entire operation of the inspection device 4, and the elements of the inspection device 4 operate under the control of the inspection controller 403. The comparison unit 404 compares the scanned image sent from the scanned-image acquisition unit 401 with the master image generated by the master-image processing unit 402, and determines whether or not image forming and outputting processes are being performed as desired. In order to perform an enormous amount of calculation at high speed, the comparison unit 404 is configured by an ASIC as described above. In the present example embodiment, the inspection controller 403 serves as an image inspection unit by controlling the comparison unit 404, and also serves as an inspection result acquisition unit that acquires the results of inspection performed by the comparison unit 404.

The comparison unit 404 compares the scanned image, which is scanned at a resolution of 200 dots per inch (dpi) where each color of RGB is expressed by 8 bits as described above, with a master image for each corresponding pixel, and calculates the value of the difference between the pixel value of each color of RGB expressed by 8 bits and the pixel value of the master image, on a pixel-by-pixel basis. Based on the comparison between the absolute value of the calculated value of difference (hereinafter, this absolute value will be referred to simply as a value of difference) and a threshold, the inspection controller 403 determines whether or not a scanned image is defective. In other words, the inspection controller 403 serves as an image inspection unit by controlling the elements of the inspection device 4.

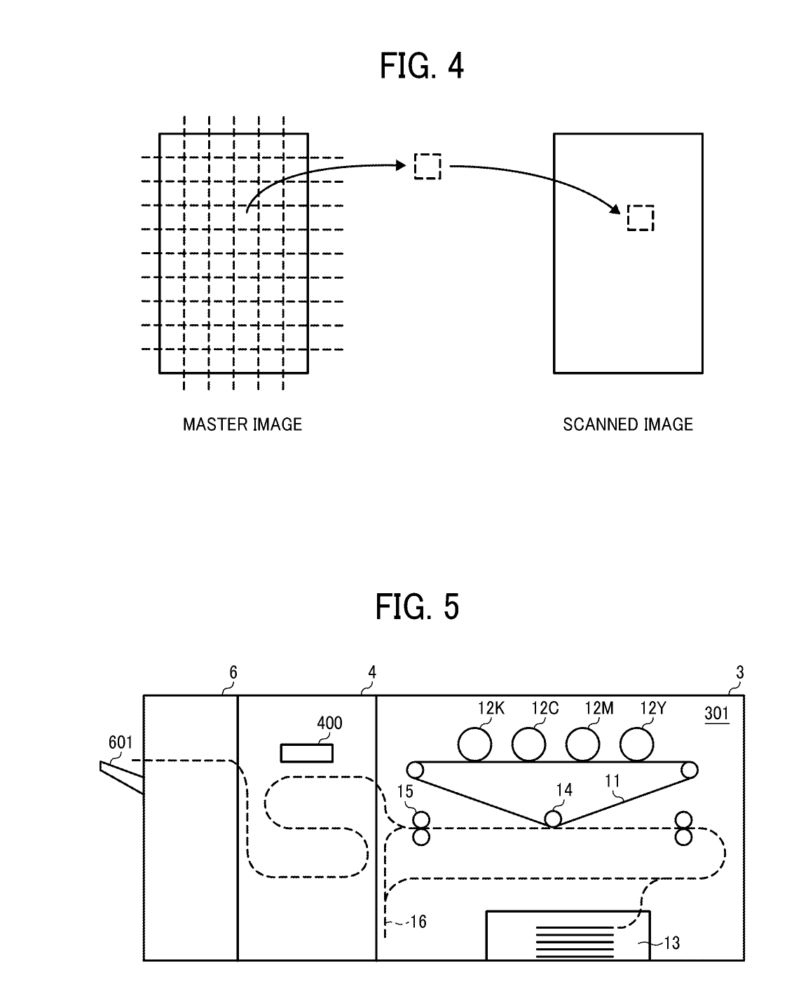

When a scanned image is compared with a master image, the comparison unit 404 calculates a difference in pixel value, i.e., a difference in density, of each pixel by superimposing the master image divided into specified ranges on the corresponding area of a piece of the scanned image, as illustrated in FIG. 4. These processes are achieved as the inspection controller 403 obtains a pair of areas of images to be superimposed on top of one another from the master image and the scanned image, respectively, and then transfers the obtained image to the comparison unit 404.

More specifically, the inspection controller 403 shifts the position at which the divided piece is superimposed on the corresponding area of the scanned image vertically and horizontally or shifts the area of image to be obtained from the scanned image, and determines the position at which the calculated value of difference becomes smallest to be an accurate superimposition point and adopts the value of difference calculated therein as a comparison result. Due to this configuration, the comparison unit 404 can transmit the value of difference calculated for each pixel and the amount of vertical and horizontal misalignment measured at the position that is determined to be the superimposition point.

As illustrated in FIG. 4, each square of the grid is a prescribed unit of area when the sum of the values of difference calculated for the respective pixels is calculated as above. The size of the divisional areas illustrated in FIG. 4 is determined on the basis of, for example, the area that the comparison unit 404, which is configured by an ASIC as described above, is capable of comparing pixel values at a time.

By performing these processes as described above, values of difference are calculated upon aligning a scanned image with a master image. Then, whether or not the image is defective is determined based on a result of the comparison between the values of difference calculated as above and a prescribed threshold. Further, even if the scale of the scanned image is different from that of the master image, the effect of such a scale difference can be reduced by performing alignment upon dividing the scanned image into specified areas as illustrated in FIG. 4.

In each divided area as illustrated in FIG. 4, it is predicted that the amounts of misalignment are relatively close to each other among areas adjacent to each other. For this reason, when comparison is performed for each divided area, the amount of misalignment determined by the comparison performed among adjacent areas is used as a representative value and calculation with shifting the position or area vertically and horizontally as described above is performed. Accordingly, the likelihood of calculation at accurate superimposing position becomes high even when the number of times calculation with shifting the position or area vertically and horizontally is performed is reduced, and the computational complexity is reduced as a whole.

Next, the mechanical configuration of a part of the print engine 3, the inspection device 4, and the stacker 6, and the conveyance of paper through the apparatus along a conveyance path are described with reference to FIG. 5. As illustrated in FIG. 5, the print processing unit 301 included in the print engine 3 according to the example embodiment of the present invention has a structure in which photoreceptor drums 12Y, 12M, 12C, and 12K corresponding to four colors (they will be referred to simply as the photoreceptor drums 12) are arranged along a conveyance belt 11, which is a seamless moving body. Such a type of photoreceptor drums is called photoreceptor drums of tandem type. In other words, a plurality of photoreceptor drums 12Y, 12M, 12C, and 12K are arranged along the conveyance belt 11, which is an intermediate transfer belt on which an intermediate transfer image to be transferred to paper (i.e., an example of recording medium) fed from a paper feed tray 13 is formed, in the order listed from the upstream side of the conveyance direction of the conveyance belt 11.

The color images of toner that are respectively formed on the surfaces of the photoreceptor drums 12 of four colors are transferred to the conveyance belt 11, such that the color images are superimposed one above the other to form a full color image on the conveyance belt 11. The full color image formed on the conveyance belt 11 as above is transferred by a transfer roller 14 to paper that has been conveyed along the path, at a position where the conveyance path of paper illustrated as broken lines in FIG. 5 gets closest to the conveyance belt 11.

The paper on which the full color image has been formed is further conveyed, and the image is fixed at a fixing unit including a fixing roller 15. Then, the paper is ejected to the inspection apparatus 4. In the case of duplex printing, the paper on a side of which the full image has been formed and fixed is conveyed to a reverse path 16 to be reversed, and is conveyed to the transfer position of the transfer roller 14 again to receive another image on the other side of paper.

The scanner 400 scans the surface of paper conveyed from the print processing unit 301 in the conveyance path of paper inside the inspection apparatus 4, and transmits the scanned image to the scanned-image acquisition unit 401 that is configured by an information processing device arranged inside the inspection apparatus 4. Then, the paper whose surface has been scanned by the scanner 400 is further conveyed inside the inspection device 4, and is conveyed to the stacker 6. Then, the paper is ejected to a paper output tray 601. In FIG. 5, the scanner 400 is provided on only one side of the conveyance path of paper in the inspection device 4. However, the scanners 400 may be provided on both sides of the conveyance path of paper in order to inspect both sides of the paper.

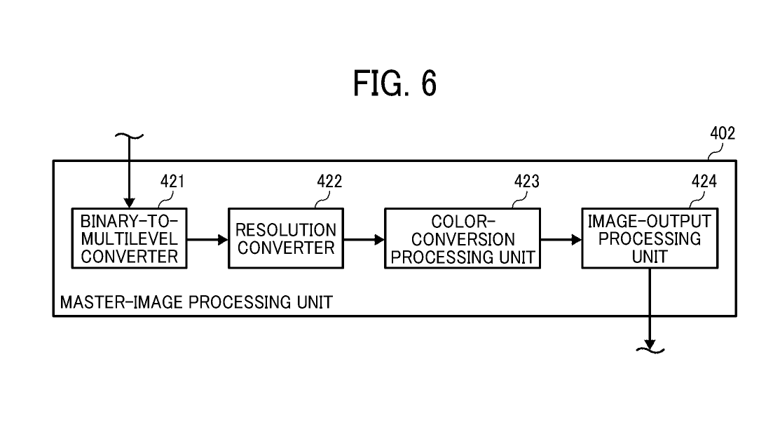

Next, the functional configuration of the master-image processing unit 402 according to the present example embodiment is described with reference to FIG. 6. FIG. 6 is a block diagram illustrating the internal configuration of the master-image processing unit 402 according to the present example embodiment of the present invention. As illustrated in FIG. 6, the master-image processing unit 402 includes a binary-to-multilevel converter 421, a resolution converter 422, a color-conversion processing unit 423, and an image-output processing unit 424. Note that the master-image processing unit 402 according to the present example embodiment is realized by hardware configured as an application-specific-integrated-circuit (ASIC), i.e., the dedicated device 80 described above with reference to FIG. 2. The dedicated device 80 operates in accordance with the control performed by software.

The binary-to-multilevel converter 421 generates a multilevel image by performing binary-to-multilevel conversion on a binary image that is expressed by two tones (colorless tone and colored tone). The bit map data according to the present example embodiment is the data that is to be input to the print engine 3, and the print engine 3 performs the image forming and outputting processes based on the binary CMYK images. By contrast, a scanned image to be inspected is a multilevel image expressed by multilevel gray scale of RGB (red, green, blue), which are three primary colors, and thus the binary-to-multilevel converter 421 firstly converts a binary image into a multilevel image. An image that is expressed, for example, by 8-bit CMYK may be used as a multilevel image.

The binary-to-multilevel converter 421 depicted in FIG. 6 performs a 8-bit expansion process and a smoothing process to achieve binary-to-multilevel conversion. In the 8-bit expansion process, 1-bit data of 0/1 is expanded to 8 bits. That is, “0” remains “0” and “1” is converted into “255”. In the smoothing process, an image is smoothed by applying a smoothing filter to the expanded 8-bit data.

In the present example embodiment, the print engine 3 performs image forming and outputting processes based on the binary CMYK images, and the master-image processing unit 402 includes the binary-to-multilevel converter 421. However, this configuration is merely given as an example. That is, when the print engine 3 performs the image forming and outputting processes based on a multilevel image, the binary-to-multilevel converter 421 may be omitted.

Moreover, the print engine 3 according to the present example embodiment may have capability of performing image forming and outputting processes based on a few-value image such as a 2-bit image, instead of a 1-bit image. In that case, the functions of a 8-bit expansion process may be modified to deal with the above case. In other words, a 2-bit image has four gradation values of 0, 1, 2, and 3. Accordingly, when a 8-bit expansion process is performed, “0”, “1”, “2”, and “3” are converted into “0”, “85”, “170”, and “255”, respectively.

The resolution converter 422 performs resolution conversion so as to adjust the resolution of the multilevel image generated by the binary-to-multilevel converter 421 to the resolution of a scanned image to be inspected. In the present example embodiment, scanner 400 generates a scanned image of 200 dpi. Accordingly, the resolution converter 422 converts the resolution of the multilevel image generated by the binary-to-multilevel converter 421 to 200 dpi.

In the present example embodiment, the resolution converter 422 generates a plurality of images that are different from each other as the resolution of these images is converted by changing the positions of segmentation of an area where the mean value of the pixels is to be calculated, when the resolution converter 422 converts the resolution of the multilevel image generated by the binary-to-multilevel converter 421. The details of the processes of the resolution converter 422 are described later. Moreover, the resolution converter 422 according to the present example embodiment adjusts the size of the resolution-converted image based on the magnification predetermined in consideration of the shrinkage or the like of paper output from the print processing unit 301.

The color-conversion processing unit 423 acquires an image whose resolution has been converted by the resolution converter 422, and converts the levels of gradation or color representation format. In the gradation-level conversion process, the color tone of a master image is adjusted to the color tone of the image formed on the paper by the print processing unit 301 and the color tone of the image scanned and generated by the scanner 400.

These processes performed by the color-conversion processing unit 423 are performed by referring to a gradation-level conversion table. The gradation conversion table is generated as follows. For example, an image that includes color patches of ranges of gradation is formed on paper by the print processing unit 301, and the paper processed by the print processing unit 301 is scanned to generate a scanned image. Then, the gradation values of the color patches on the scanned image are associated with the gradation values of the original image of the color patches, and the results are described in the gradation-level conversion table. In other words, the color-conversion processing unit 423 converts the gradation value of each color of the image output from the resolution converter 422, based on such a gradation-level conversion table.

In the conversion of a color representation format, a CMYK image is converted into an RGB image. Because the scanned image according to the present example embodiment is an RGB image as described above, the color-conversion processing unit 423 converts a CMYK image for which a gradation-level conversion process has been performed into an RGB image. Accordingly, a multilevel image of 200 dpi where each pixel is expressed by 8-bit RGB (24 bits in total) is generated. In other words, in the present example embodiment, the binary-to-multilevel converter 421, the resolution converter 422, and the color-conversion processing unit 423 serve as an inspection image generation unit.

The image-output processing unit 424 outputs the master images generated by the color-conversion processing unit 423. As a result, the inspection controller 403 receives the master images from the master-image processing unit 402. In the present example embodiment, the color-conversion processing unit 423 processes each of the resolution-converted images generated by the resolution converter 422. Accordingly, a plurality of master images are generated. The image-output processing unit 424 according to the present example embodiment outputs the generated multiple master images. As described above, a plurality of master images are generated in the present example embodiment.

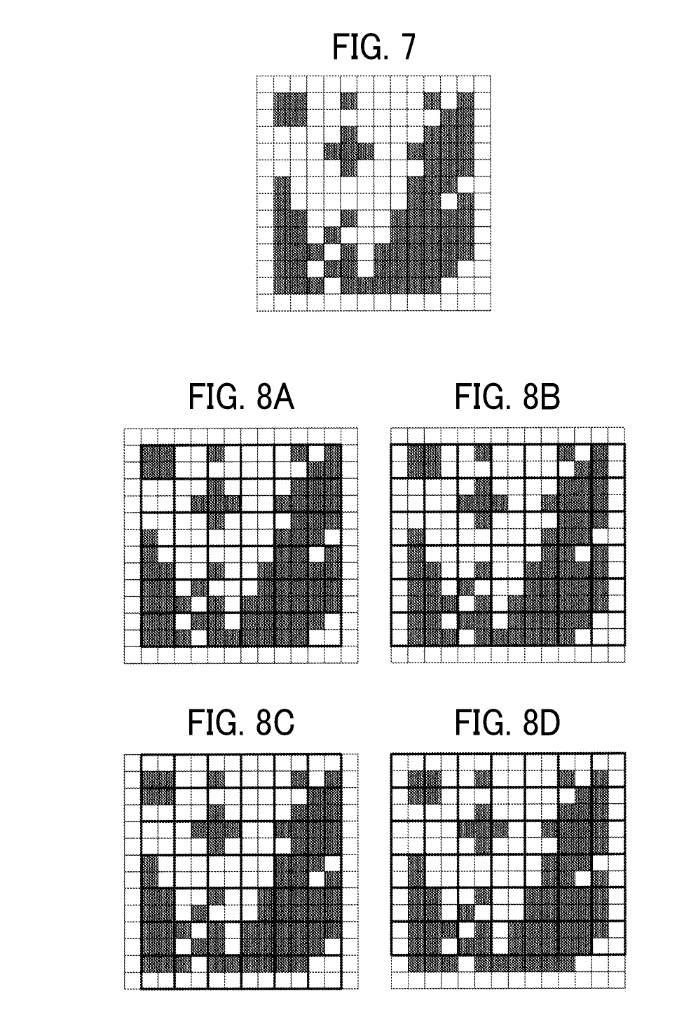

Next, how the resolution converter 422 generates a plurality of resolution-converted images is described. FIG. 7 illustrates an example of the multilevel image generated by the binary-to-multilevel converter 421, according to the present example embodiment of the present invention. In FIG. 7, it is assumed that the pixels shaded by dots have higher density than the hollow pixels that are not shaded by dots.

The resolution converter 422 performs resolution conversion so as to adjust the resolution of the multilevel image of FIG. 7 to the resolution of a scanned image to be inspected. In the present example embodiment, cases in which the resolution of the multilevel image is 400 dpi and the resolution of a scanned image to be inspected is 200 dpi have been described by way of example. In such cases, for the purpose of downsizing the multilevel image by fifty percent, the resolution converter 422 divides the multilevel image illustrated in FIG. 7 into 2*2 pixel segments and generates a resolution-converted image where the mean value of the pixel values of the four pixels of each divided segment is adopted as the pixel value of the corresponding single pixel of the resolution-converted image. Although the cases in which a multilevel image is divided into 2*2 pixel segments are described by way of example in the present example embodiment, the number of pixels included in each divided segment may be any number depending on the resolution of a scanned image to be inspected or the resolution of an image for which resolution conversion has been performed.

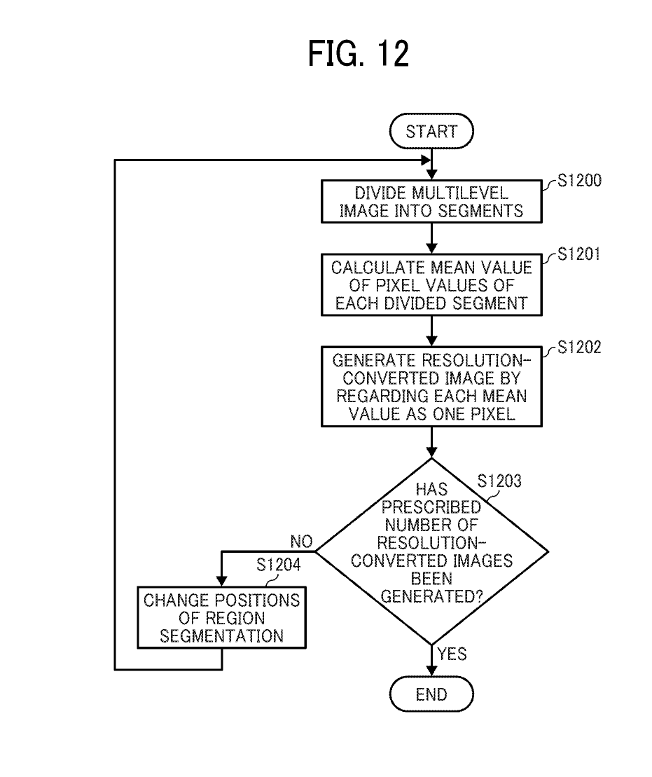

In the present example embodiment, the resolution converter 422 serves as a resolution-converted image generator that divides the multilevel image illustrated in FIG. 7 into pixel segments with a plurality of patterns having varied positions of segmentation to generate a plurality of resolution-converted images. FIG. 12 is a flowchart depicting the processes of generating a plurality of resolution-converted images performed by the resolution converter 422 according to the present example embodiment. In the present example embodiment, cases in which four different resolution-converted images are generated are described by way of example.

As depicted in FIG. 12, the resolution converter 422 divides a multilevel image into segments using a single pattern of segmentation (S1200). FIGS. 8A to 8D illustrate four patterns of a multilevel image where the positions of region segmentation are varied, according to the present example embodiment. In FIGS. 8A to 8D, the lines of region segmentation are indicated by bold lines. Firstly, the case of dividing a multilevel image into segments as in S1200 with the pattern of positions of segmentation illustrated in FIG. 8A is described by way of example. FIG. 8A illustrates the pattern in which a pair of rows of pixels on the top and bottom sides of the multilevel image and a pair of columns of pixels on the right and left sides of the multilevel image are excluded from region segmentation and the rest of the pixels of the multilevel image is divided into 2*2 pixel segments.

After the multilevel image is divided into segments, the resolution converter 422 calculates the mean value of the pixel values of each of the divided four pixels (S1201). After the mean value is calculated for each of the divided segment, the resolution converter 422 generates a resolution-converted image by regarding each of the calculated mean values as the pixel value of one pixel (S1202).

After the resolution-converted image is generated, the resolution converter 422 determines whether or not a prescribed number of different resolution-converted images (i.e., four resolution-converted image in the present example embodiment) have been generated (S1203). The resolution converter 422 generates a prescribed number of different resolution-converted images (“YES” in S1203), and terminates the process.

When the prescribed number of different resolution-converted images have not yet been generated (“NO” in S1203), the resolution converter 422 changes the positions of region segmentation (S1204). Then, the resolution converter 422 divides the multilevel image into segments using a different pattern of segmentation where the positions of segmentation are varied (S1200), and repeats the processes in S1201 to S1203.

In order to generate four resolution-converted images, the resolution converter 422 performs the processes in S1200 to S1202 with the pattern illustrated in FIG. 8A, and then repeats the processes in S1200 to S1202 with, for example, the patterns illustrated in FIGS. 8B to 8D. Note that FIG. 8B illustrates the pattern obtained by shifting the positions of segmentation illustrated in FIG. 8A to the left by one pixel. FIG. 8C illustrates the pattern obtained by shifting the positions of segmentation illustrated in FIG. 8A to the top by one pixel. FIG. 8D illustrates the pattern obtained by shifting the positions of segmentation illustrated in FIG. 8B to the top by one pixel.

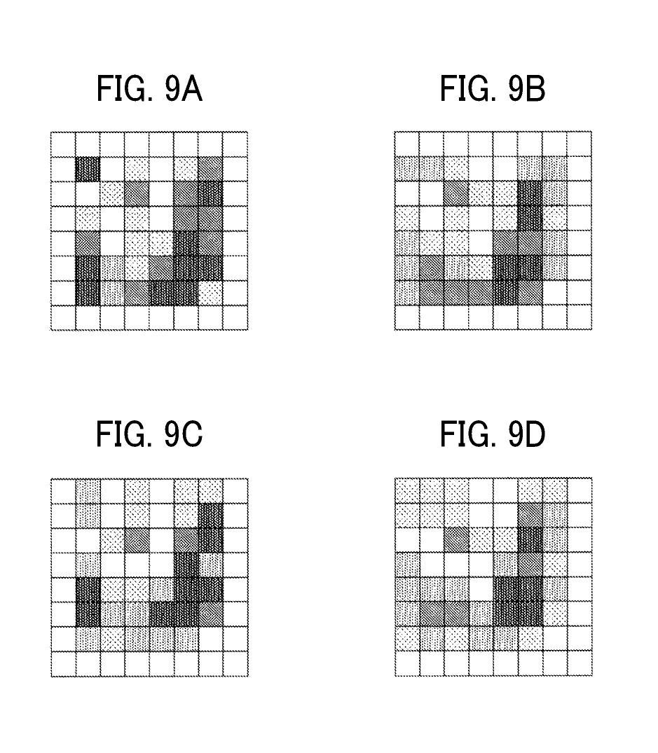

FIGS. 9A to 9D illustrate examples of a plurality of resolution-converted images generated by performing the processes depicted in FIG. 12 with the four patterns illustrated in FIGS. 8A to 8D. FIGS. 9A to 9D illustrate the resolution-converted images that are generated based on the pixel values of the segments divided with the respective patterns illustrated in FIGS. 8A to 8D. As the number of the pixels shaded by dots is greater in FIGS. 8A to 8D, the density of each pixel becomes higher in the resolution-converted images illustrated in FIGS. 9A to 9D. Note that a pixel with higher density is shaded by dots of higher density in FIGS. 9A to 9D.

As described above, the resolution converter 422 generates a plurality of resolution-converted images as illustrated in FIGS. 9A to 9D. After that, the color-conversion processing unit 423 performs color conversion on the generated resolution-converted images as described above to generate a plurality of master images. The image-output processing unit 424 outputs the master images generated by the color-conversion processing unit 423.

The resolution-converted images in FIGS. 9A to 9D may be compared with each other as follows. For example, the pixel that is second from the left and is second from the top has the highest density in FIG. 9A, but the pixel that is second from the left and is second from the top has the third-highest density in FIG. 9D. As described above, two resolution-converted images that are generated from the same multilevel image may have different density of pixels, as illustrated in FIGS. 9A to 9D, depending on the segmentation patterns used for dividing the multilevel image.

In a similar manner, the scanned images obtained from the same printed material may also have different arrangement of pixels as the position at which the printed material is scanned varies slightly for every scanning process. For this reason, for example, while a certain scanned image is determined to be not defective as the difference between the scanned image and the master image generated from the resolution-converted image illustrated in FIG. 9A is small, another scanned image of the same printed material may be determined to be defective as the difference between the latter scanned image and the master image generated from the resolution-converted image illustrated in FIG. 9A is significantly large.

Moreover, even when the scanning position does not vary, scanned images may have different arrangement of pixels. Accordingly, even if these scanned images are recognized as the identical image by visual perception of humans, some of these scanned images may be determined to be defective when compared with a master image where determination is made for every pixel using a difference image. For this reason, for example, while a certain scanned image is determined to be not defective as the difference between the scanned image and the master image generated from the resolution-converted image illustrated in FIG. 9A is small, another scanned image of the same printed material with the same scanning position but with different arrangement of pixels may be determined to be defective as the difference between the latter scanned image and the master image generated from the resolution-converted image illustrated in FIG. 9A is significantly large.

As described above, if inspection is performed based on only one of the master images that are generated from the resolution-converted images illustrated in FIGS. 9A to 9D, a scanned image of appropriate printed material may be determined to be defective in error.

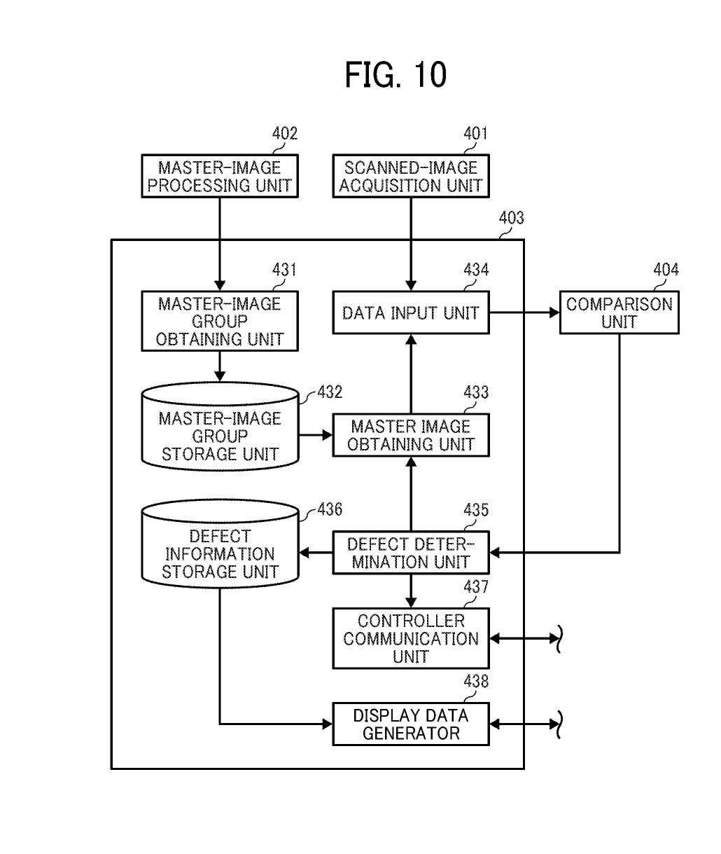

In the present example embodiment, a plurality of different master images are generated, and whether or not a scanned image is defective is determined based on the generated multiple master images. The functional configuration of the inspection controller 403 according to the present example embodiment is described below with reference to FIG. 10.

FIG. 10 is a block diagram of the functional configuration of inspection controller 403 according to the present example embodiment of the present invention. As illustrated in FIG. 10, the inspection controller 403 according to the present example embodiment includes a master-image group obtaining unit 431, a master-image group storage unit 432, a master image obtaining unit 433, a data input unit 434, a defect determination unit 435, a defect information storage unit 436, a controller communication unit 437, and a display data generator 438.

The master-image group obtaining unit 431 obtains a group of master images from the master-image processing unit 402, and stores the obtained group of group of master images in the master-image group storage unit 432. Each group of master images includes a plurality of master images generated by performing color conversion on the resolution-converted images as illustrated in FIGS. 9A to 9D. The master-image group storage unit 432 is a memory for storing the group of master images obtained by the master-image group obtaining unit 431.

The master-image obtaining unit 433 obtains one of the groups of master images from the master-image group storage unit 432, and transmits the obtained group of master images to the data input unit 434. Moreover, the master-image obtaining unit 433 obtains another one of the groups of master images, which has not yet been obtained, from the master-image group storage unit 432 based on the notification from the defect determination unit 435, and transmits the obtained group of master images to the data input unit 434.

Note that the order of the master images that the master-image obtaining unit 433 obtains from the master-image group storage unit 432 is determined in advance. For example, a main master image and sub master images are specified in the master images of the master-image group, and the master-image obtaining unit 433 firstly obtains the main master image, and transmits the obtained main master image to the data input unit 434. Then, the master-image obtaining unit 433 obtains one of the sub master images according to the notification from the defect determination unit 435, and transmits the obtained sub master image to the data input unit 434.

For example, a main master image is generated from the resolution-converted image illustrated in FIG. 9A, which was generated by dividing the multilevel image in the region that was determined in advance by the resolution converter 422. Moreover, the sub master images are generated from the resolution-converted images illustrated in FIGS. 9B to 9D.

The data input unit 434 obtains the master image input from the master-image obtaining unit 433, and also obtains a scanned image from the scanned-image acquisition unit 401. Moreover, the data input unit 434 extracts certain areas of the master image and the scanned image and inputs the extracted areas of the master image and the scanned image to the comparison unit 404, and the comparison unit 404 performs comparison between the pair of extracted images, as illustrated in FIG. 4.

As a result of the comparison performed by the comparison unit 404, a difference image that indicates the values of difference between the pixels of a scanned image and the pixels of a master image is generated. The defect determination unit 435 obtains the generated difference image of the certain area, and determines whether or not the scanned image is defective based on the obtained difference image. Depending on the result of the determination, the defect determination unit 435 determines whether the scanned image is defective again based on the difference image obtained as a result of comparison made between the scanned image and another master image that is different from the master image used for generating the previously-obtained difference image.

When it is determined that a certain inspected area of the scanned image is defective, the defect determination unit 435 stores the defect information including the position of the defect in the defect information storage unit 436. The details of the series of processes of determining whether a scanned image is defective are described later.

The controller communication unit 437 controls the engine, for example, by sending a re-printing request to the engine, based on the result of defect detection performed by the defect determination unit 435. The display data generator 438 generates display data for displaying on the interface terminal 5 the defect information stored in the defect information storage unit 436, and outputs the generated display data to the interface terminal 5. The interface terminal displays the information about defects based on the display data input from the display data generator 438.

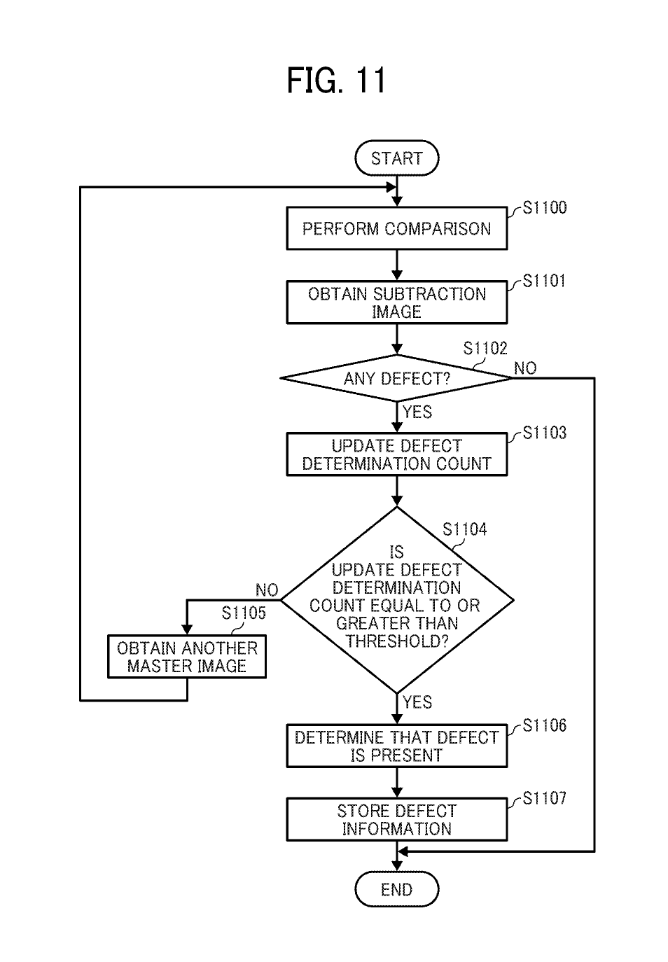

Next, the details of the series of processes of determining whether a scanned image is defective, which are performed by the components of the inspection device 4 illustrated in FIG. 10, are described below with reference to FIG. 11. FIG. 11 is a flowchart of the details of the series of processes of determining whether a scanned image is defective, which are performed by the components of the inspection device 4 illustrated in FIG. 10. As illustrated in FIG. 11, the data input unit 434 firstly extracts certain areas (areas to be inspected) from the master image input from the master-image obtaining unit 433 and the scanned image input from the scanned-image acquisition unit 401, and then inputs the extracted areas of the master image and the scanned image to the comparison unit 404. Accordingly, the comparison unit 404 performs comparison between the pair of extracted images (S1100).

The defect determination unit 435 obtains the difference image of the areas to be inspected generated by the comparison performed by the comparison unit 404 (S1101). After the difference image is obtained, the defect determination unit 435 determines whether or not the scanned image is defective in the areas to be inspected by comparing the sum (or average) of the pixel values of the obtained difference image in the areas to be inspected (hereinafter, such a sum or average of pixel values will be referred to as “value of difference”) with a threshold (S1102). When it is determined that the scanned image is not defective (i.e., determined that the sum is smaller than the threshold) (“NO” in S1102), the defect determination unit 435 terminates the process of determining whether or not the scanned image is defective because no defect is present and the edges of the master image and the scanned image match.

On the other hand, when it is determined by the defect determination unit 435 that the scanned image is defective (i.e., determined that the sum is equal to or greater than the threshold) (“YES” in S1102), there are two possibilities. One possibility is that a defect is actually present, and the other possibility is that defects are detected to an excessive degree as the edges of the master image and the scanned image differ due to slight misalignment. For this reason, the defect determination unit 435 firstly updates the defect determination count that indicates the number of times defects are detected (S1103). For example, the initial value of the defect determination count is set to zero and increases by one every time the updating process is performed.

After the defect determination count is updated, the defect determination unit 435 determines whether or not the defect determination count is equal to or greater than a threshold (S1104). Note that the threshold of the defect determination count is determined in advance according to, for example, the statistical analysis performed on the thresholds used in the past. When the defect determination count is smaller than the threshold (“NO” in S1104), the master-image obtaining unit 433 obtains another master image, which is different from the previous master image used to generate the difference image, from the master-image group storage unit 432 based on the notification from the defect determination unit 435 (S1105).

Then, the data input unit 434 extracts areas of image to be inspected from the different master image input from the master-image obtaining unit 433 in S1105 and the scanned image input from the scanned-image acquisition unit 401, and inputs the extracted areas of the master image and the scanned image to the comparison unit 404. Accordingly, the comparison unit 404 performs comparison again between the pair of extracted images (S1100). Note that it is assumed that the areas of image to be inspected extracted when comparison is performed again as above are same as the areas of image to be inspected of the difference image that was used to determine that the scanned image is defective.

In a similar manner to the processes described above, when it is determined that the scanned image is not defective based on the difference image generated from the different master image and the scanned image (“NO” in S1102), the defect determination unit 435 determines that the defect was detected in error and terminates the process.

On the other hand, when it is determined that the scanned image is defective (“YES” in S1102), the defect determination unit 435 updates the defect determination count (S1103) in a similar manner to the processes described above, and then determines whether or not the defect determination count is equal to or greater than a threshold (S1104). When the defect determination count is smaller than the threshold (“NO” in S1104), the master-image obtaining unit 433 obtains a further different master image from the master-image group storage unit 432, and repeats the processes in a similar manner to the processes described above.

On the other hand, when the defect determination count is equal to or greater than the threshold (“YES” in S1104), the defect determination unit 435 determines that the scanned image is actually defective (S1106) instead of determining that the detection of defect is an error. This is because the possibility that the detection of defect is an error due to variations in arrangement of the pixels of the scanned image is low when the defect determination count, i.e., the number of the different master images used for determining that the scanned image is defective, is equal to or greater than the threshold.

When it is determined that the scanned image is defective, the defect determination unit 435 stores in the defect information storage unit 436 the defect information including the defective area of image (for example, the top-left coordinates or bottom-right coordinates of the area) and the value of the difference in the defective area (S1107). By performing such processes as described above for each of the segments illustrated in FIG. 4, the image inspection according to the present example embodiment of the present invention is completed. When it is determined by the defect determination unit 435 that the scanned image is not defective (“NO” in S1102), the operation of image inspection is terminated without processing the other segments.

As described above, the inspection device 4 according to the example embodiment of the present invention generates a plurality of master images that are different from each other. Even if the scanned image is determined to be defective based on the difference image generated from one of the master images and the scanned image, such detection of defect may be determined to be an error when it is later determined that the scanned image is not defective based on the difference image generated from another one of the master image and the scanned image. Accordingly, erroneous detection of error due to variations in arrangement of the pixels of a scanned image is reduced, and the accuracy of inspection improves.

The inspection device 4 according to the example embodiment of the present invention generates a plurality of master images independently of the scanned image. Accordingly, the scanned image and the master image may be generated in parallel, and the speed of the inspection improves.

In the example embodiment described above, cases are described in which a threshold used for determining whether the scanned image is defective based on a values of difference is constant regardless of the type of the components of the image. However, when an edge is included in the areas of image to be inspected, the threshold used for determining whether the scanned image is defective based on the value of the difference of such areas may be increased (for example, doubled) compared with the threshold for the other areas. Because the density changes greatly at an edge, even if the change in scanning position is very small, the pixel values at the same positions of the scanned image of the same printed material may vary greatly. Accordingly, in the absence of any defect, the values of difference between the scanned image and the master image may become greater at an edge that at the other area.

For this reason, by making the threshold of determining whether an edge-including image is defective be greater than the thresholds of determining whether the other images are defective, it becomes possible to determine whether an edge-including image is defective more precisely. In such cases, edge extraction is performed, for example, by using a Laplacian filter, on the areas of image to be inspected. When an edge is extracted, the threshold used for determining whether the scanned image is defective based on the value of the difference of such areas is made greater than the threshold for the other areas.

In the example embodiment described above, when it is determined that any area of a scanned image is defective based on a certain master image, the same defect detection is performed again based on another master image, regardless of the type of the components of the areas of image to be inspected. However, such repeated defect detection as described above with reference to FIG. 11 may be performed only when any edge is included in the areas of image to be inspected.

Because the density changes greatly at an edge, even if the change in scanning position is very small, the pixel values at the same positions of the scanned image of the same printed material may vary greatly. Accordingly, when defect detection is performed only on a single master image, an edge-including area of image is more likely determined to be defective than an edge-free area of image. For this reason, such repeated defect detection may be performed only when any edge is included in the areas of image to be inspected, in order to reduce erroneous detection and improve the accuracy of inspection. Moreover, the cost of performing repeated defect detection may also be reduced by adopting the configuration in which repeated defect detection is not performed on all the images.

In the example embodiment described above, defect detection processes are terminated when it is determined that a scanned image is not defective based on the master image that is firstly obtained by the master-image obtaining unit 433. Alternatively, it may be configured such that even when it is determined that a scanned image is not defective based on the master image that is firstly obtained by the master-image obtaining unit 433, defect detection is performed again based on another master image. In this configuration, the scanned image is determined to be defective when the defect determination count is equal to or greater than a threshold in the latter defect detection. Accordingly, erroneous determination can be reduced in which a scanned image is determined to be not defective by chance based on the master image that is firstly obtained by the master-image obtaining unit 433 despite the fact that the scanned image is actually defective.

In the example embodiment described above, when it is determined that any area of a scanned image is defective based on a master image, the same defect detection is performed again based on another master image. In such cases, the latter defect detection is performed on the certain area of the image. This configuration prevents the cost of performing defect detection from increasing. However, no limitation is indicated therein. It may be configured such that when it is determined that any area of a scanned image is defective based on a master image, defect detection is performed again based on the difference image between the entirety of the scanned image and the entirety of another master image.

In the example embodiment described above, the resolution of a multilevel image is converted, and color conversion is performed on the resolution-converted image to generate a master image. Alternatively, filtering may be further performed on the image on which color conversion is performed to fit to the blurred focus of the scanned image, prior to the generation of a master image.

In the example embodiment described above, a plurality of resolution-converted images are generated by varying the positions of the segmentation of a multilevel image, and a plurality of master images are generated accordingly. Alternatively, instead of generating a plurality of images when resolution converting processes are performed, a plurality of filtered images whose arrangements of the pixels are different from each other may be generated when the filtering is performed as described above, for example, by varying the filtering coefficients, to generate a plurality of master images.

Numerous additional modifications and variations are possible in light of the above teachings. It is therefore to be understood that within the scope of the appended claims, the disclosure of the present invention may be practiced otherwise than as specifically described herein. For example, elements and/or features of different illustrative embodiments may be combined with each other and/or substituted for each other within the scope of this disclosure and appended claims.

Further, as described above, any one of the above-described and other methods of the present invention may be embodied in the form of a computer program stored in any kind of storage medium. Examples of storage mediums include, but are not limited to, flexible disk, hard disk, optical discs, magneto-optical discs, magnetic tapes, nonvolatile memory cards, ROM, etc. Alternatively, any one of the above-described and other methods of the present invention may be implemented by ASICs, prepared by interconnecting an appropriate network of conventional component circuits, or by a combination thereof with one or more conventional general-purpose microprocessors and/or signal processors programmed accordingly.

What is claimed is:

1. An image inspection device comprising:
an inspection image generation unit configured to generate a plurality of inspection images for inspecting a read image obtained by reading an output image formed and output by an image forming apparatus; and
a defect determination unit configured to determine whether the read image is defective based on a difference image indicating a difference between the read image and at least one of the plurality of generated inspection images.

2. The image inspection device according to claim 1, wherein the plurality of inspection images generated by the inspection image generation unit have pixels whose density is different from each other.

3. The image inspection device according to claim 2, wherein the inspection image generation unit includes a resolution-converted image generator configured to generate a plurality of resolution-converted images whose resolution is converted to fit resolution of the read image by varying positions of dividing the image data of the output image into segments.

4. The image inspection device according to claim 1, wherein
the defect determination unit determines whether the read image is defective based on the difference image indicating a difference between the read image and one of the generated inspection images, and
when it is determined that the read image is defective, the defect determination unit determines whether the read image is defective again based on a difference image indicating a difference between the read image and another one of the generated inspection images that is different from the inspection image previously used for determining that the scanned image is defective.

5. The image inspection device according to claim 4, wherein the defect determination unit determines that the read image is defective when a number of the inspection images used for determining that the read image is defective is equal to or greater than a prescribed threshold.

6. The image inspection device according to claim 1, wherein when an edge is included in the read image to be inspected, the defect determination unit determines whether the read image is defective based on a difference image indicating a difference between the read image and at least two of the inspection images that are different from each other.

7. The image inspection device according to claim 1, wherein the inspection image generation unit performs filtering to fit to blurred focus of the read image when the plurality of inspection images are generated.

8. The image inspection device according to claim 7, wherein the inspection image generation unit generates a plurality of filtered images by varying filtering coefficients used for the filtering, and generates the plurality of inspection images based on the generated plurality of filtered images.

9. An image inspection system comprising:
an image forming unit configured to form and output an output image on a recording medium based on an image to be formed and output;
an image reading unit configured to read an image from the recording medium to generate a read image;
a read-image acquisition unit configured to acquire the generated read image;
an inspection image generation unit configured to generate a plurality of inspection images for inspecting the acquired read image; and
a defect determination unit configured to determine whether the read image is defective based on a difference image indicating a difference between the read image and at least one of the plurality of generated inspection images.

10. The image inspection device according to claim 9, wherein the plurality of inspection images generated by the inspection image generation unit have pixels whose density is different from each other.

11. The image inspection device according to claim 10, wherein the inspection image generation unit includes a resolution-converted image generator configured to generate a plurality of resolution-converted images whose resolution is converted to fit resolution of the read image by varying positions of dividing the image data of the output image into segments.

12. The image inspection device according to claim 9, wherein
the defect determination unit determines whether the read image is defective based on the difference image indicating a difference between the read image and one of the generated inspection images, and
when it is determined that the read image is defective, the defect determination unit determines whether the read image is defective again based on a difference image indicating a difference between the read image and another one of the generated inspection images that is different from the inspection image previously used for determining that the scanned image is defective.

13. The image inspection device according to claim 12, wherein the defect determination unit determines that the read image is defective when a number of the inspection images used for determining that the read image is defective is equal to or greater than a prescribed threshold.

14. The image inspection device according to claim 9, wherein when an edge is included in the read image to be inspected, the defect determination unit determines whether the read image is defective based on a difference image indicating a difference between the read image and at least two of the inspection images that are different from each other.

15. The image inspection device according to claim 9, wherein the inspection image generation unit performs filtering to fit to blurred focus of the read image when the plurality of inspection images are generated.

16. The image inspection device according to claim 15, wherein the inspection image generation unit generates a plurality of filtered images by varying filtering coefficients used for the filtering, and generates the plurality of inspection images based on the generated plurality of filtered images.

17. A computer-readable non-transitory recording medium storing a program for causing a computer to execute a method, the method comprising:
generating a plurality of inspection images for inspecting a read image obtained by reading an output image formed and output by an image forming apparatus; and
determining whether the read image is defective based on a difference image indicating a difference between the read image and at least one of the plurality of generated inspection images.
